(19) United States
(12) Patent Application Publication
(10) Pub. No.: US 2007/0211978 A1
(43) Pub. Date: Sep. 13, 2007

(54) Roller bearing with preloading

(76) Inventors: Martin Engesser, Donaueschingen (DE); Stefan Schwamberger, Hermsdorf (DE)

Correspondence Address: COOPER & DUNHAM, LLP, 1185 AVENUE OF THE AMERICAS, NEW YORK, NY, 10036, US

(21) Appl. No.: 11/713,274

(22) Filed: Mar. 2, 2007

(30) Foreign Application Priority Data
Mar. 8, 2006 (DE) 10 2006 010 655.5

(51) Int. Cl. F16C 33/66

(52) U.S. Cl. 384/517

(57) ABSTRACT

The invention relates to a roller bearing with preloading that comprises a first bearing ring, a second bearing ring and roller members disposed between these two parts, and at least one elastic element that is disposed on the first bearing ring or on a component connected to the first bearing ring and that exercises a preload force on the second bearing ring. According to the invention the preload force generated by the elastic element is transferred to the second bearing ring by means of at least one first bearing. The bearings are preferably fluid dynamic bearings. However, additional roller bearings may be used.

### BACKGROUND OF THE INVENTION

The invention relates to a roller bearing with preloading, wherein a radial bearing, an axial bearing or an angular contact bearing may be provided.

### PRIOR ART

In traditional roller bearing applications, both fixed and movable bearing systems are used. A movable bearing compensates for production tolerances, wear and tear and temperature expansion through changes in the position of the bearing parts.

Should greater running smoothness and/or lower bearing noise be required, two fixed bearings, for example, are mounted with a defined preload. Examples of spindle motors having preloaded roller bearing systems can be found in EP 1148619 A2, EP 0752537 B1 and EP 0770998 B1.

To compensate for temperature expansion, separate components having appropriate expansion coefficients are used to some extent. DE 195 18 670 C2 reveals a roller bearing having an integrated elastic element to compensate tolerance. Another possibility is to use spring elements that tension the bearings vis-à-vis one another by means of their spring force.

Alongside the retainer and roller members, a conventional roller bearing generally consists of an inner bearing ring (inner race) and an outer bearing ring (outer race) and of cover disks or sealing disks. Depending on the sealing requirement, these disks are designed as contact or non-contact disks. If the sealing disks touch their respective rotation partner (inner or outer race), bearing losses and frictional wear are then produced which go to limit the useful life of the bearing, particularly if the sealing disk is under high pressure. DE 101 48 388 A1 reveals this kind of roller bearing having a contact sealing disk.

Using this kind of sealing disk, the inner and outer race can be tensioned vis-à-vis one another. To this effect, the sealing disk is designed, for example, as a Belleville spring washer, it is fixed to the inner or to the outer race and is pressed axially (radially) onto the other bearing ring using its spring force. The preload depends on the spring force of the Belleville spring washer and is only negligibly dependent on the temperature since the spring travel is much greater than the heat expansion of the components.

Springs require additional space and give rise to additional costs. Adjusting a defined preload for two fixed bearings is a very difficult process. In addition, the preload can change due to parts tolerances and wear. Nor does the preload remain constant when components are used to compensate heat expansion. If the bearing preload is incorrect, noise behavior is made worse. If there is too much preload, useful life is reduced through frictional wear, and large bearing losses occur.

Optimum lubrication of the contact surfaces can only counteract bearing losses to a limited extent.

### SUMMARY OF THE INVENTION

It is the object of the invention to improve a roller bearing with preloading such that an almost constant preload over a large temperature range is achieved without requiring any additional space or components. Furthermore, compared to conventional roller bearings, bearing losses should be reduced.

This object has been achieved through a roller bearing having the characteristics outlined in claim 1.

Beneficial embodiments and further developments of the invention are cited in the subordinate claims.

The roller bearing according to the invention comprises a first bearing ring, a second bearing ring, roller members disposed between these two parts and at least one elastic element that is disposed on the first bearing ring or on a component connected to the first bearing ring and that exercises a preload force on the second bearing ring, the preload force generated by the elastic element being transferred to the second bearing ring by means of a first bearing.

In a first embodiment of the invention, the elastic element, which can be designed, for example, as a spring washer or as a Belleville spring washer, preferably has a radial flange that lies opposite one face of the second bearing ring, the first bearing being disposed between the radial flange and the face of the second bearing ring.

In another embodiment, the elastic element rests against a first annular component that lies opposite one face of the second bearing ring, the first bearing being disposed between the first annular component and the face of the second bearing ring.

Here, the elastic element can be fixedly connected to the first bearing ring while moving with respect to the second bearing ring.

In another embodiment of the invention, the elastic element is made to float between the two bearing rings, the elastic element having a second radial flange that lies opposite one face of the first bearing ring or a component connected to the first bearing ring, a second bearing being disposed between the radial flange and the face of the first bearing ring or of the component respectively.

In an alternative embodiment, the elastic element can have a rubber-elastic core that has a sliding coating on at least one side. The coating lies opposite an associated end face of a bearing ring, the first and/or the second bearing being disposed between the coating and the end face of the associated bearing ring.

In the above-mentioned embodiments, provision can be made for the elastic element and/or at least one of the annular components to act concurrently as a seal in order to seal the roller bearing towards the outside.

Preferably the first and/or the second bearing are fluid dynamic bearings. However, a roller bearing may also be used. The preferably fluid dynamic preloaded roller bearing according to the invention makes it possible to construct fixed and movable bearing systems without needing to use an additional spring element. Moreover, it also makes it possible to preload a single roller bearing.

In using a fluid dynamic bearing, one of the surfaces facing each other of the first and/or of the second bearing has a grooved pattern which is at least proportionally filled with a bearing fluid. The grooved pattern is designed as a pumping pattern that ensures the distribution of the bearing fluid in the bearing gap between the surfaces facing each other of the first and/or of the second bearing on rotation of the fluid dynamic bearing.

In addition to the grooved pattern, a free space, such as a circular groove, can be provided in the face of the first and/or the second bearing ring or the component connected to the first bearing ring at the inside and/or at the outside diameter of the bearing surface, the space being at least proportionally filled with bearing fluid and forming a reservoir for the bearing fluid. The space is connected to the adjoining grooved pattern, so that the fluid held there can be conveyed into the grooved pattern on rotation of the bearing.

The fluid dynamic bearings could be sealed by providing at least one sealing ring at the elastic element or the annular component.

Depending on the direction of rotation of the roller bearing and the design of the respective grooved pattern in the bearing rings, either the first or the second fluid dynamic bearing becomes load bearing while the surfaces of the other bearings rest against each other.

In using a roller bearing to support the elastic element, roller members are disposed on one of the surfaces facing each other of the first and/or of the second bearing, these roller members rolling on the other surface respectively. This kind of roller bearing can be operated in both rotational directions without any restrictions.

### BRIEF DESCRIPTION OF THE DRAWINGS

FIG. 1 shows a perspective sectional view of a first embodiment of a radial deep groove ball bearing according to the invention.

FIG. 2 shows a section through the deep groove ball bearing according to FIG. 1.

FIG. 2a shows an enlarged view of detail B in FIG. 2.

FIG. 3 shows an enlarged view of detail A in FIG. 2.

FIG. 4 shows a modified form of a deep groove ball bearing in an enlarged view similar to FIG. 3.

FIG. 5 shows a perspective sectional view of a second embodiment of a radial deep groove ball bearing according to the invention.

FIG. 6 schematically shows a section through a further embodiment of a roller bearing according to the invention.

FIG. 7 schematically shows an embodiment of the elastic element.

FIG. 8 schematically shows an enlarged view of the bearing region between the annular component and the outer bearing ring in FIG. 6.

FIG. 9 shows an S-shaped spring element.

FIG. 10 shows a U-shaped spring element.

FIG. 11 shows a rubber-elastic element.

### DETAILED DESCRIPTION OF PREFERRED EMBODIMENTS OF THE INVENTION

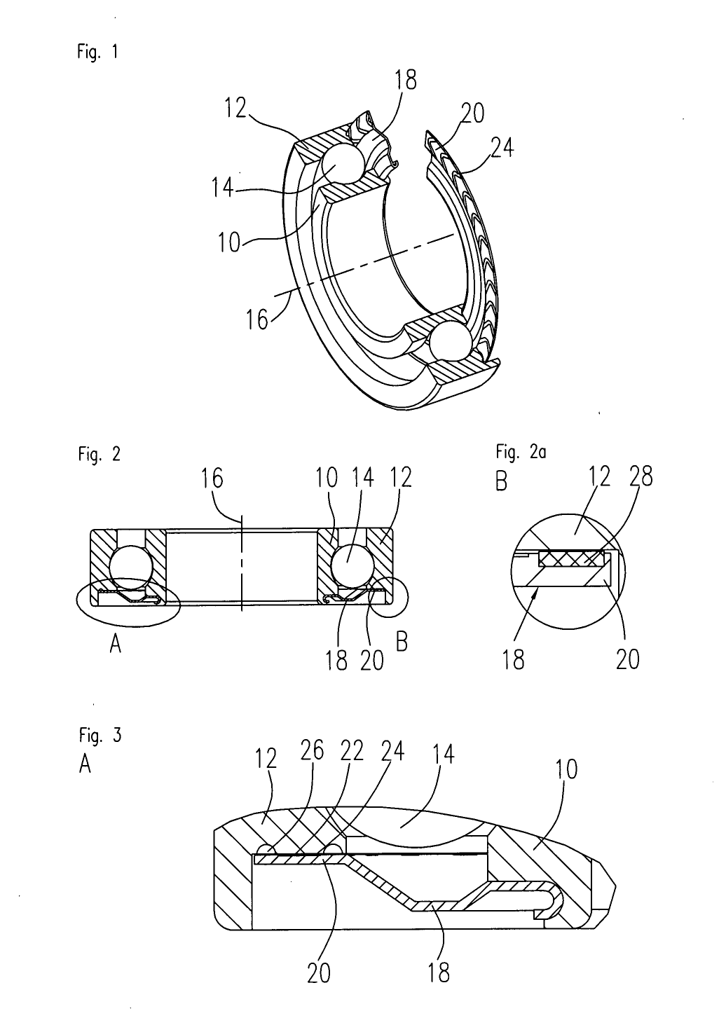

FIGS. 1 to 4 show a first embodiment of a radial deep groove ball bearing according to the invention having a fluid dynamic bearing to rotatably support an elastic element taking the form of a spring washer 18.

The deep groove ball bearing comprises a first inner bearing ring 10, a second outer bearing ring 12 and roller members 14 disposed between these two parts that are preferably held in a ball retainer (not illustrated). The deep groove ball bearing makes it possible for the outer bearing ring 12 to rotate with respect to the inner bearing ring 10 about a rotational axis 16. A cover disk taking the form of a spring washer 18 is fixedly connected on one side to a face of the inner bearing ring 10. The other side of the spring washer 18 has a radial flange 20, i.e. set transversely to the rotational axis 16 that lies opposite an end face 22 of the outer bearing ring 12. When the deep groove ball bearing is at rest, the flange 20 rests against the end face 22 of the outer bearing ring 12 and is so formed that it exercises a preload force on the outer bearing ring 12.

According to the invention, the surfaces facing each other of the flange 20 and the face 22 of the outer bearing ring 12 form the sliding surfaces of a fluid dynamic bearing. The sliding surfaces are separated from one another by a bearing gap. One of the two surfaces, the surface of the flange 20 in the example illustrated, has a grooved pattern 24 that is at least proportionally filled with a bearing fluid. The grooved pattern 24 forms a pumping pattern in a well-known manner for the purposed of distributing the bearing fluid in the bearing gap between the surfaces facing each other of the fluid dynamic bearing. On rotation of the deep groove ball bearing, the outer bearing ring 12 rotates with respect to the flange 20 of the spring washer 18, the flange 20 lifting from the face 22 of the outer bearing ring 12 by means of the pumping action on the bearing fluid and the fluid dynamic effect thus created.

Since the viscosity of the bearing fluid, preferably a liquid lubricant, depends greatly on the temperature, the height by which the flange 20 of the spring washer 18 lifts (flies) up from the face 22 of the outer bearing ring 12 can vary. This variation in height amounts to only a few μm over a large temperature range. It is thus small compared to the overall spring travel and is therefore not significant for the preload of the roller bearing.

The spring washer 18 additionally acts as a seal for the roller bearing. Differences in pressure on the spring washer 18 in turn affect the flying height of the spring washer 18 over the opposite surface. However, these differences in height amount to only a few μm over a wide pressure range and hardly detract from the sealing function at all. Bearing friction and frictional wear are considerably reduced when compared to a traditional sealing disk. The useful life of the bearing is extended significantly as a result.

Air, oil or bearing grease can be used as the bearing fluid. If a liquid fluid is used, a supply of this bearing fluid for the useful life of the bearing should preferably be provided. FIG. 3 shows a possible embodiment of a fluid reservoir in the region of the outside diameter of the spring washer 18. The fluid reservoir is given the form of a free space or a groove 26 that is formed in the face 22 of the outer bearing ring 12. The fluid dynamic grooved patterns 24 engage in this groove 26 and convey fluid into the actual bearing patterns. This process ends when an equilibrium between inward (out of the fluid reservoir) pumping forces and those acting outwards is produced. The free space 26 may also be given the form of a conical space having an outer opening, as schematically shown in FIG. 8.

If there is a risk, however, of the fluid leaving the fluid dynamic region, which could occur, for example, when there are large process tolerances or through the fluid being pressed out during the transition from rotation to standstill, then two fluid reservoirs may also be used. These can then be disposed on each side of the fluid dynamic grooved patterns 24 (inner and outer). The grooved patterns then engage in both reservoirs and ensure a continual supply of fluid.

As shown in FIG. 2a, a sealing ring 28 can be provided near the free end of flange 20 of the spring washer 18. The sealing ring 28 assures that the bearing fluid does not leave the fluid dynamic bearing region during stand standstill or during the transition from standstill to rotation of the roller bearing.

Sealing rings similar to the one shown in FIG. 2a could be provided at the elastic elements 118, 218, 322, 418, 518 and 618 or the annular component 320 of the other embodiments of invention which are described below.

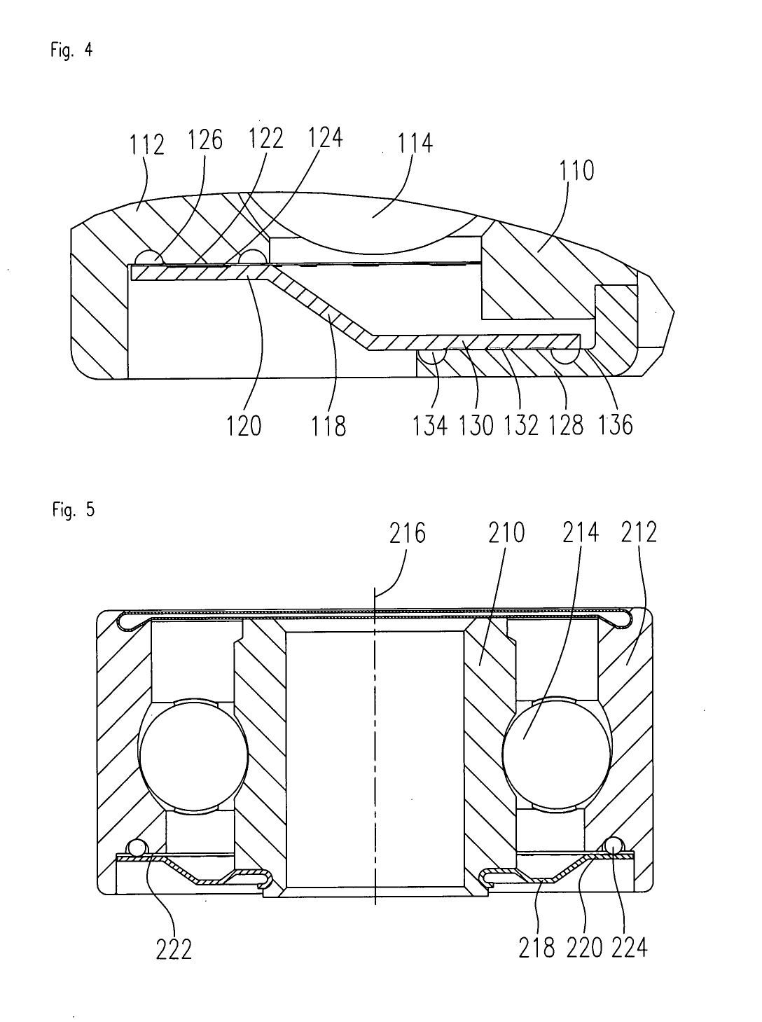

FIG. 4 is a modified embodiment of the roller bearing according to FIGS. 1 to 3. The roller bearing comprises an inner bearing ring 110, an outer bearing ring 112 and roller members 114 disposed between these two parts, as well as a spring washer 118 having a first radial flange 120 that lies opposite a face 122 of the outer bearing ring 112 and forms a first fluid dynamic bearing with this face. As described above, the fluid dynamic bearing is marked by a grooved pattern 124 and can comprise one groove 126 or two grooves in the outside and inside circumference acting as a fluid reservoir.

According to this embodiment, the spring washer 118 has a second radial flange 130 that lies opposite a face 136 of an annular component 128 connected to the inner bearing ring 110. A second fluid dynamic bearing is formed between this radial flange 130 and the face 136 of the component 128. The fluid dynamic bearing is marked by grooved patterns 132 that are provided on the bearing surfaces of the flange 130. At least one groove 134 can further be provided as a fluid reservoir, the at least one groove being connected to the bearing patterns 132.

This embodiment makes it possible to operate the roller bearing in both rotational directions. Depending on the rotational direction of the roller bearing and the design of the respective grooved pattern, either the first or the second fluid dynamic bearing becomes load bearing, while the surfaces of the other bearing rest against each other.

FIG. 5 shows another embodiment of the roller bearing having a roller bearing supported preload. The roller bearing comprises an inner bearing ring 210, an outer bearing ring 212 and roller members 214 disposed between these two parts, as well as a spring washer 218 having a first radial flange 220 that lies opposite a face 222 of the outer bearing ring 212. The spring washer 218 may be formed almost exactly like the embodiments according to FIGS. 1 to 3. A plurality of roller members 224, preferably balls projecting slightly beyond the surface of the face 222, are preferably disposed in a groove in the face 222 of the outer (or of the inner) bearing ring 212. The roller members 224 rest against the adjoining surface of the flange 220 and roll on this surface on rotation of the roller bearing. This type of roller bearing supported preload also allows operation of the roller bearing in both rotational directions.

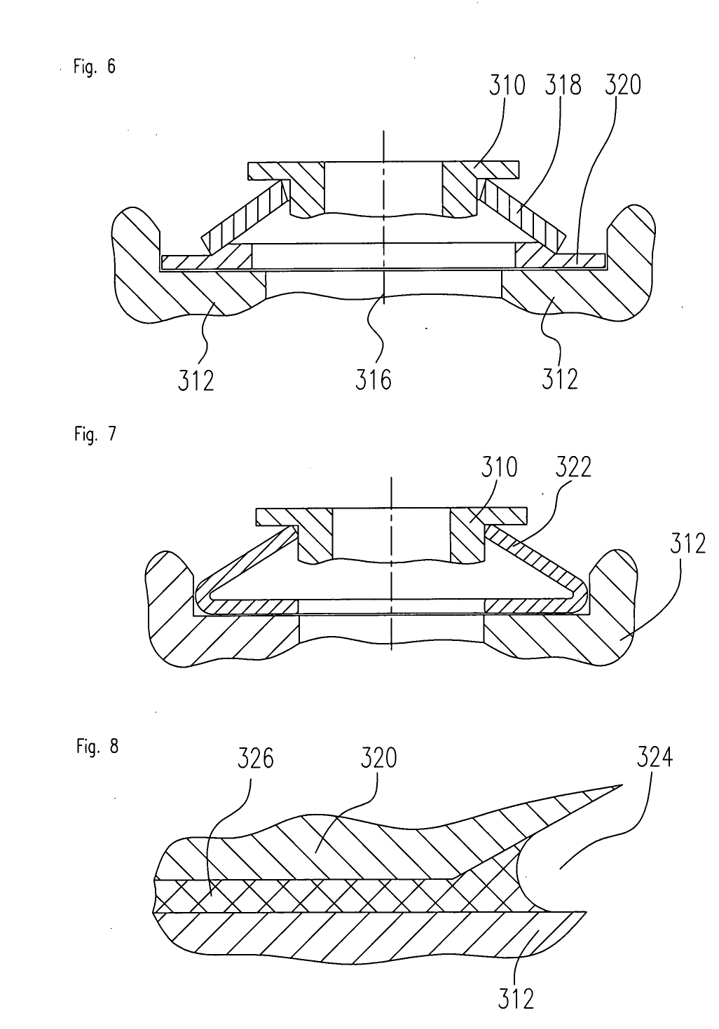

Another embodiment of a roller bearing according to the invention having an inner bearing ring 310 and an outer bearing ring 312 is shown in FIG. 6. The roller members are not illustrated. A Belleville spring washer 318 is supported at the edge of the inner bearing ring 310 and exercises a spring force on an annular component 320 that transfers the spring force to the outer bearing ring 312. Here, the surfaces facing each other of the annular component 320 and one face of the outer bearing ring 312 form the sliding surfaces of a fluid dynamic bearing of the type described above, which is used to transfer the spring force to the outer bearing ring 312.

FIG. 7 shows another embodiment of an elastic element 322 that can, for example, replace the Belleville spring washer 318 as well as the annular component 320 shown in FIG. 6.

An enlarged view of the bearing region between the annular component 320 and the outer bearing ring 312 in FIG. 6 or respectively between the element 322 and the outer bearing ring 312 is shown in FIG. 8. While forming a bearing gap 326 filled with a bearing fluid, the two components 312 and 320 define a fluid dynamic bearing. It can be seen that one edge of the annular component 320 is preferably beveled, so that a conical space 324, which acts as a reservoir for the bearing fluid, is formed between the two components 312, 320. The free space 324 concurrently forms a conical capillary seal to seal the bearing gap 326.

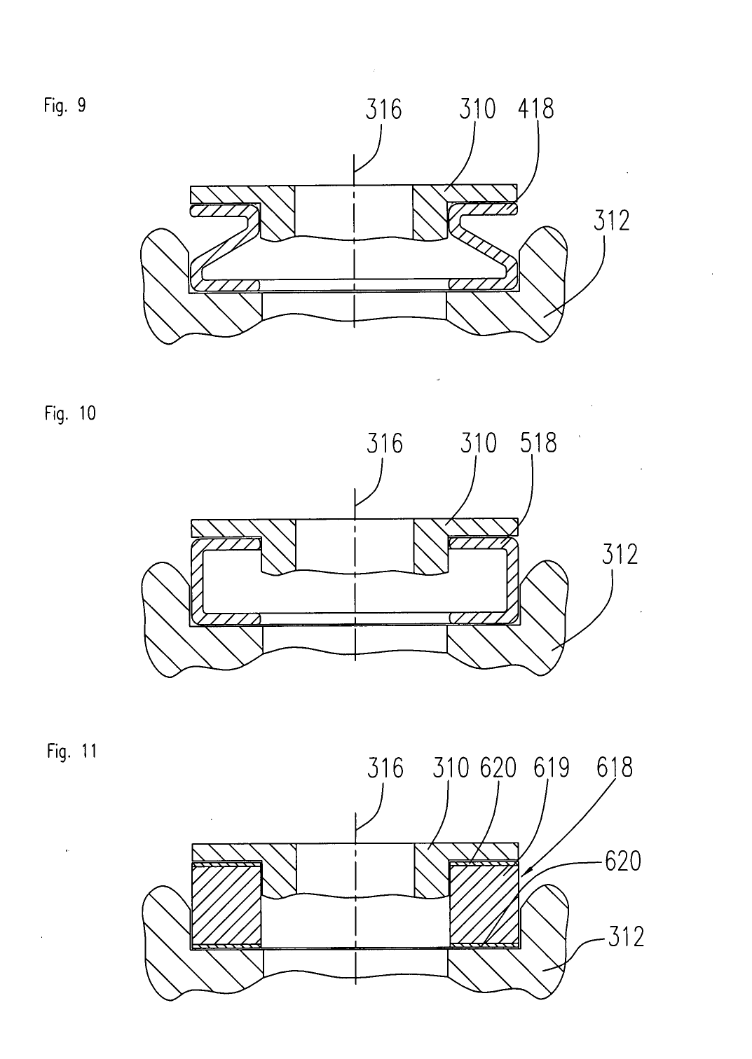

According to the invention, other designs for the elastic element are also conceivable, such as an S-shaped spring element 418 as shown in FIG. 9 or a U-shaped spring element 518 according to FIG. 10. In each case, the elastic element 418 or 518 has appropriate flanges that have integrated sliding surfaces which interact with the sliding surfaces of the respective bearing ring and form a fluid dynamic sliding bearing.

FIG. 11 presents a further embodiment of an elastic element 618. The elastic element 618 preferably consists of a rubber-elastic core 619 that has a coating 620 on one or two sides which act as appropriate sliding surfaces.

The fluid dynamic or roller bearing supported preloaded roller bearings according to the invention make it possible to substantially reduce bearing losses and noise generation. Moreover, a relatively constant preload over a large temperature range can be achieved.

### IDENTIFICATION REFERENCE LIST

10 Bearing ring, inner
12 Bearing ring, outer
14 Roller member
16 Rotational axis
18 Spring washer
20 Flange
22 End face (bearing ring, outer)
24 Grooved pattern
26 Groove/space
28 Sealing ring
110 Bearing ring, inner
112 Bearing ring, outer
114 Roller member
118 Spring washer
120 Flange
122 End face (bearing ring, outer)
124 Grooved pattern
126 Groove/space
128 Component
130 Flange
132 Grooved pattern
134 Groove/space
136 Face (component)
210 Bearing ring, inner
212 Bearing ring, outer
214 Roller member
216 Rotational axis
218 Spring washer
220 Flange
222 End face (bearing ring, outer)
224 Roller member
310 Bearing ring, inner
312 Bearing ring, outer
316 Rotational axis
318 Belleville spring washer
320 Component (annular)
322 Elastic element
324 Conical space
326 Bearing gap
418 Spring element
518 Spring element
618 Elastic element
619 Rubber-elastic core
620 Coating (sliding surface)

1. A roller bearing having a first bearing ring, a second bearing ring and roller members disposed between the first bearing ring and second bearing ring, and at least one elastic element that is disposed on the first bearing ring or on a component connected to the first bearing ring and that exercises a preload force on the second bearing ring,
characterized in that
the preload force generated by the elastic element (18; 118; 218; 318; 322; 418; 518; 618) is transferred to the second bearing ring by means of the first bearing.

2. A roller bearing according to claim 1, characterized in that the elastic element (18; 118; 218; 318; 322; 418; 518) is a spring elastic element, a spring washer or a Belleville spring washer.

3. A roller bearing according to claim 1, characterized in that the elastic element (18; 118; 218; 418; 518) has a radial flange (20; 120; 220) that lies opposite an end face (22; 122; 222) of the second bearing ring, the first bearing being disposed between the radial flange and the end face of the second bearing ring.

4. A roller bearing according to claim 1, characterized in that the elastic element (318; 322) rests against a first annular component (320) that lies opposite an end face of the second bearing ring, the first bearing being disposed between the first annular component (320) and the face of the second bearing ring.

5. A roller bearing according to claim 1, characterized in that the elastic element (18; 218; 318; 322) is fixedly connected to the first bearing ring.

6. A roller bearing according to claim 1, characterized in that the elastic element (118; 418; 518) has a second radial flange (130) that lies opposite an end face of the first bearing ring or a component (128) connected to the first bearing ring, a second bearing being disposed between the radial flange and the face of the first bearing ring or of the component.

7. A roller bearing according to claim 1, characterized in that the elastic element (318; 322) rests against a second annular component that lies opposite a face of the first bearing ring, a second bearing being disposed between the second annular component and the face of the first bearing ring.

8. A roller bearing according to claim 1, characterized in that the elastic element (618) has a rubber-elastic core (619) that has a sliding coating (620) on at least one side, the coating lying opposite an associated end face of a bearing ring, the first and/or the second bearing being disposed between the coating and the end face of the associated bearing ring.

9. A roller bearing according to claim 7, characterized in that it is sealed by means of the elastic element (18; 118; 218; 318; 322; 418; 518; 618) and/or at least one of the annular components (320).

10. A roller bearing according to claim 4, characterized in that the first and/or the second bearing is a fluid dynamic bearing whose bearing surfaces are formed by the surfaces facing each other of the flange (20; 120; 130; 220) of the elastic element (18; 118; 218; 418; 518) or of the annular component (320) respectively and the face of the associated bearing ring.

11. A roller bearing according to claim 10, characterized in that one of the bearing surfaces facing each other of the first and/or of the second fluid dynamic bearing has a grooved pattern (24; 124; 132) that is at least proportionally filled with a bearing fluid.

12. A roller bearing according to claim 11, characterized in that the grooved pattern (24; 124; 132) is a pumping pattern for the purpose of distributing the bearing fluid between the bearing surfaces facing each other of the first and/or of the second bearing.

13. A roller bearing according to claim 11, characterized in that a free space (26; 126; 134; 324) is provided in the end face of the first and/or of the second bearing ring or of the component connected to the first bearing ring at the inside and/or at the outside diameter of the bearing surface, the space being at least proportionally filled with bearing fluid and forming a reservoir for the bearing fluid.

14. A roller bearing according to claim 13, characterized in that the space (26; 126; 134; 324) is connected to the adjoining grooved pattern (24; 124; 132).

15. A roller bearing according to claim 11, characterized in that depending on its rotational direction and the design of the respective grooved pattern (124; 132), the first or the second fluid dynamic bearing becomes load bearing, while the bearing surface of the other bearing rest against each other.

16. A roller bearing according to claim 10, characterized in that the elastic element (18; 118; 218; 322; 418; 518; 618) or the annular component (320) is provided with at least one sealing ring (28) for sealing the respective fluid dynamic bearing.

17. A roller bearing according to claim 4, characterized in that the first and/or the second bearing is a roller bearing whose bearing surfaces are formed by the surfaces facing each other of a flange (220) of the elastic element (218) or of the annular component (320) respectively and the faces of the bearing rings.

18. A roller bearing according to claim 17, characterized in that roller members (224) are disposed on one of the bearing surfaces facing each other of the first and/or of the second bearing, the roller members rolling on the other bearing surface respectively.
